(19) United States
(12) Patent Application Publication
(10) Pub. No.: US 2026/0044855 A1
(43) Pub. Date: Feb. 12, 2026

(54) SYSTEMS AND METHODS FOR EXTENDING AUTHENTICATION

(71) Applicant: MASTERCARD INTERNATIONAL INCORPORATED, PURCHASE, NY (US)

(72) Inventors: Manu Dharmaiah Kallugudde, Fair Lawn, NJ (US); Deepa Thakkar, Metuchen, NJ (US); Jason Eckert, Deer Park, NY (US)

(21) Appl. No.: 19/278,578

(22) Filed: Jul. 23, 2025

Related U.S. Application Data
(60) Provisional application No. 63/682,305, filed on Aug. 12, 2024.

(51) Int. Cl. G06Q 20/40; G06Q 20/32

(52) U.S. Cl. CPC G06Q 20/401; G06Q 20/322

(57) ABSTRACT

Systems and methods are provided for extending authentication. An example computer-implemented method includes, during a checkout session at a mobile device specific to a user, and in response to a lookup request from a first party, confirming a user profile for the user and an existing passkey for the user profile and a mobile device associated with the user. The method also includes, during the checkout session, initiating a passkey authentication of the user, through a fast identity online (FIDO) server at the mobile device; receiving a proof of authentication for the user from the FIDO server; providing the proof of authentication to the first party; receiving an instruction to initiate checkout from the first party; validating the proof of authentication based on a session ID, without a further passkey authentication of the user, and compiling an authentication payload based on the validated proof of authentication.

### CROSS-REFERENCE TO RELATED APPLICATION

This application claims the benefit of, and priority to, U.S. Provisional Patent Application No. 63/682,305, filed on Aug. 12, 2024. The entire disclosure of the above application is incorporated herein by reference.

### FIELD

The present disclosure generally relates to systems and methods for use in extending authentication of users for the duration of sessions in which the users are authenticated.

### BACKGROUND

This section provides background information related to the present disclosure which is not necessarily prior art.

Users are known to interact with different entities, through networks, for a variety of reasons. From time to time, as part of the interactions, the entities desire to authenticate the users to confirm identities of the users, for example, to ensure the users are the correct users or the actual users for specific identities, as compared to different users claiming to be the users, etc. In one example, an entity may leverage fast identity online (FIDO) as a form of authentication. As part of FIDO authentication, the entity enrolls the user, with a private key generated and stored in a device of the user (e.g., a smartphone, etc.) and a public key, which is shared with and stored by the entity.

Subsequently, for each part of an interaction with the entity, the user is authenticated with the entity based on a message from the device, which is signed by the private key, and which is authenticated by the public key held by the entity. For example, as part of checkout, the user is authenticated to a user profile and then the user is authenticated again in connection with checkout using one of the accounts from the user profile.

### BRIEF DESCRIPTION OF DRAWINGS

The drawings described herein are for illustrative purposes only of selected embodiments and not all possible implementations, and are not intended to limit the scope of the present disclosure:

FIG. 1 illustrates an example system for use in authentication of users for the duration of sessions in which the users are authenticated;

FIG. 2 is a block diagram of an example computing device that may be used in the system of FIG. 1;

FIG. 3 illustrates an example method that may be implemented via the system of FIG. 1, for authentication of users for the duration of sessions in which the users are authenticated; and

FIG. 4 illustrates a sequence of example interfaces for use in the system of FIG. 1 and/or the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Through FIDO authentication, parties develop connections with the users, which permit the users to be authenticated for certain activities with the parties. Later, when the users interact with the parties, each communication with the parties requires authentication. For example, during a conventional checkout interaction, a user is authenticated to retrieve a user profile, and then the user is authenticated again when the user seeks to checkout based on content of the user profile (e.g., selected account, etc.). In this way, the authentication generally is limited to the specific communication between the user and a given party, and is not extended for a duration of a session (e.g., a checkout session, etc.) therebetween. As a consequence, for various interactions, the user is forced to authenticate multiple times. The multiple authentications not only create friction with the user, but also operate to create redundant and duplicative network traffic, for the repeated messages for authentication, throughout the session.

Uniquely, the systems and methods herein provide for extending the authentication of users for the duration of sessions in which the users are authenticated.

In particular, as part of an interaction between a user and a party, such as, for example, a merchant, the user is authenticated through a passkey sequence (i.e., leveraging a private key on the user's device and a public key at the party (or FIDO server associated with the party)) between the user (e.g., the user's device) and the party. The authentication is attached to the session (or a session ID for the session) between the user and the party, whereby further communication between the user and the party, which is during that session, does not require re-authentication of the user. In this manner, the network traffic between the user's device and the party (or FIDO server) is reduced (e.g., fewer authentications of the user mean fewer authentication messages, etc.), while also maintaining the security defined by the passkey sequence of authenticating the user.

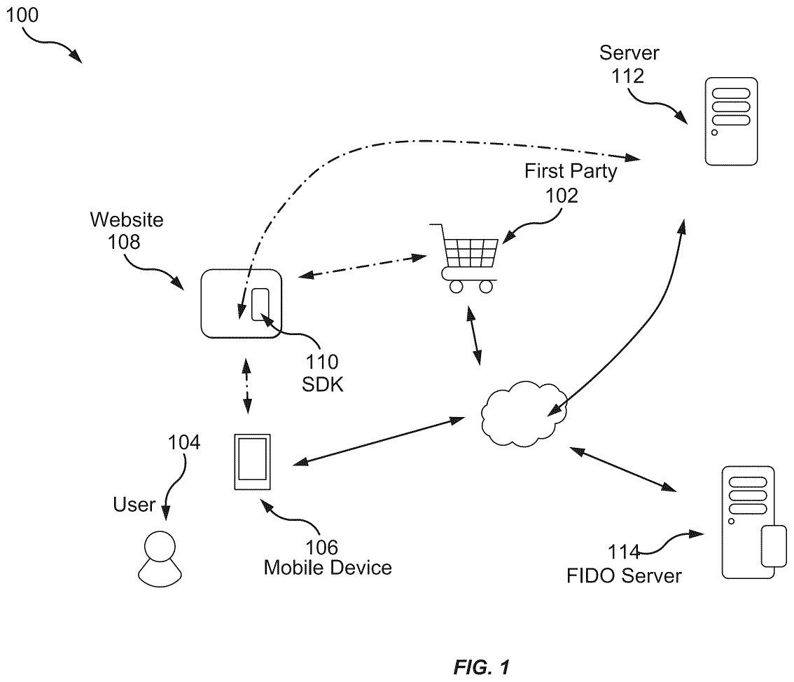

FIG. 1 illustrates an example system 100 for leveraging fast identity online (FIDO) authentication to access a first party 102 and/or applications, accounts, etc., associated with the first party 102. It should be appreciated that other passkey-based authentication schemes, beyond FIDO authentication, may be employed in other embodiments.

As shown in FIG. 1, the system 100 includes the first party 102, a mobile device 106 associated with a user 104, a service provider (or server) 112, and a fast identity online (FIDO) server 114, each coupled in communication through one or more networks. The one or more networks, as illustrated as a cloud in FIG. 1, may include one or more local area networks (LANs), wide area networks (WANs) (e.g., the Internet, etc.), mobile networks, virtual networks, other networks as described herein, and/or other suitable public and/or private networks capable of supporting communication among two or more of the illustrated parts, or even combinations thereof. In one example, the one or more networks includes multiple networks, where different ones of the multiple networks are accessible to different parts/entities illustrated in FIG. 1.

The first party 102, in this example embodiment, is a merchant, which offers products (e.g., goods, services, etc.) for sale and sells the products to users, for example, including the user 104. That said, it should be appreciated that the first party 102 may be other than a merchant in other embodiments, whereby the interactions between the user 104 and the first party 102 may be for purposes other than the purchase of products.

In this example embodiment, the first party 102 is accessible as a virtual location by the mobile device 106 (or other computing device) through a website 108, which is accessible by the mobile device 106, via a browser application (not shown) of the mobile device 106. The website 108 may be managed and/or provided directly by the first party 102, or it may be managed and/or provided by another entity on behalf of the first party 102, etc. The website 108 is executed by the mobile device 106, through the browser application, to permit the user 104 to browse, view, and/or search among one or more products (e.g., good, services, etc.) or related pages, to select product(s) for purchase from the first party 102, and to proceed to checkout to purchase the selected product(s). In connection therewith, one or more cookies may be generated by the mobile device 106 and stored at the mobile device 106 or the first party 102.

The mobile device 106 may include any suitable mobile computing device, such as, for example, a smartphone, a tablet, a laptop, a desktop, etc., and further may include other non-mobile computing device, such as, for example, desktop computers, etc. In this embodiment, the mobile device 106 is generally specific to the user 104, such that enrollment of the mobile device 106 for use in authentication of the user 104 is permissible and proper.

The service provider 112 is configured to offer one or more services to the first party 102, or to the user 104, through the first party 102, in general or in connection with the purchase of the one or more products. The services offered by the service provider 112 may vary depending on, for example, the first arty 102, the user 104, etc. In this example embodiment, the service provider 112 and also the FIDO server 114 are integrated, in whole or in part, in a processing network, such as, for example, the MASTERCARD processing network, etc., or alternatively, in the first party 102, etc. in other example embodiments. Consequently, in this example embodiment, the service provider 112 is configured to offer payment-related services, which may be employed at checkout for the first party 102. In particular, the service provider 112 is configured to offer click-to-pay or C2P services for the first party 102, whereby payment by users, including the user 104, may be simplified at checkout.

In connection therewith, the website 108 of the first party 102 includes a software-development kit (SDK) 110, which is specific to the C2P service(s) of the service provider 112. As part of the website 108, the SDK 110 configures the mobile device 106 and/or the first party 102 to communicate with the service provider 112, as explained below. That said, it should be appreciated that the SDK 110 is one manner of configuring the same to enable communication between the first party 102 and the service provider 112, while other manners of supporting communication may be employed in other embodiments. For example, the service provider 112 may be configured to expose an application programming interface (API), which is accessible to the first party 102 to communicate as described herein.

In this example embodiment, to access the C2P service of the service provider 112, the user 104 is enrolled specific to the first party 102 (e.g., for authentication thereto, etc.) and/or the service provider 112, prior to use of the C2P service for checkout at the first party 102.

As part of enrollment, the user 104 accesses the website 108, or another website associated with the first party 102 (or the service provider 112) at the mobile device 106 and requests to register for an account generally, or more specifically, for passwordless authentication of the user 104, through use of a passkey.

In response to a request from the user 104, the mobile device 106 is configured, by the SDK 110, to communicate with the FIDO server 114, directly or through the service provider 112. As part thereof, the mobile device 106 is configured to request a challenge from the FIDO server 114. The FIDO server 114 is configured, in response, to send a challenge (e.g., one-time-passcode, nonce, etc.) to the mobile device 106.

In response to the challenge, the mobile device 106 is configured to authenticate the user 104, via a biometric, a PIN, or other suitable technique. That is, the mobile device 106 is accessible to the user 104 based on authentication for various operating systems. For example, where the mobile device 106 is a smartphone, the smartphone may require a biometric to be presented, or a PIN to be entered, which the smartphone is configured to then verify to permit access thereto. In this embodiment, the mobile device 106 is configured to authenticate the user 104 in a similar manner, and then, based on successful authentication, to generate a key pair for the enrollment. The key pair includes a private key and a public key. The mobile device 106 is configured to store the private key in a secure location in the mobile device 106 (e.g., a trusted platform module (TPM), a trusted execution element (TEE), a secure element (SE), etc.). The mobile device 106 is configured to return the challenge (signed by the private key), the public key and a credential ID, along with an email address of the user 104, a phone number associated with the user 104 and/or the mobile device 106, etc., to the FIDO server 114. The FIDO server 114, in turn, is configured to verify the signature on the challenge using the public key and, when verified (if applicable), to store the returned data in a data structure (e.g., memory, a database, etc.). The FIDO server 114 is configured to then confirm to the mobile device 106, and to the service provider 112, that the passkey is created and available for the user 104 and the mobile device 106. The user 104 is then considered enrolled with the FIDO server 114.

Based on the enrollment, the service provider 112 is configured to compile and store a user profile for the user 104, which includes the email address, the phone number, and also the credential ID. The public key is not part of the user profile (e.g., as long as the FIDO server 114 is separate from the service provider 112, etc.). The user 104 may continue in the communication with the service provider 112 to add accounts to the user profile (e.g., a payment account, etc.) for use in the C2P service in checkout at the first party 102.

As such, the user 104 is enrolled for passkey or passwordless access to the service(s) from the service provider 112, at the website 108 of the first party 102, in lieu of entering a password or other credential to identify himself/herself. It should be appreciated that the passkey access is generally specific to the first party 102 and/or the service provider 112, etc.

Subsequently, the user 104 accesses the website 108 of the first party 102, at the mobile device 106, in order to browse for one or more products for purchase from the first party 102. In connection therewith, the user 104 selects a product to add to a shopping cart and then selects an option for click-to-pay checkout, which includes the C2P service from the service provider 112. In response, the first party 102 is configured to initiate a checkout session for the website 108, which includes a specific reference session ID (i.e., the session ID recorded for the session), and to also initiate the SDK 110. The first party 102 is then configured, by the SDK 110, to solicit an email address or phone number from the user 104, at the mobile device 106. The user 104, in turn, enters the phone number or email address, whereupon, the first party 102 is configured, by the SDK 110, to perform a user lookup with the service provider 112 for the user 104, based on the email address and/or phone number.

The service provider 112 is configured to receive the lookup request, to perform the requested lookup based on the mobile number, email address, etc., and to respond with an indication that the user profile exists for the user 104 and that a passkey associated with the FIDO server 114 exists for authentication of the user 104.

Upon receipt of the indication of the existing passkey, the first party 102 is configured, by the SDK 110, through the service provider 112, to initiate a passkey authentication. In connection therewith, the service provider 112 is configured to initiate the passkey authentication with the FIDO server 114 based on the mobile phone number, email address, or other user identifier. In response, the FIDO server 114 is configured to generate a challenge (e.g., a randomly generated number, nonce, etc.) and to transmit the challenge to the mobile device 106. Upon receipt of the challenge, the mobile device 106 is configured, by the SDK 110, through the service provider 112, to authenticate the user 104 locally at the mobile device 106. The authentication may include, as above, biometric or PIN authentication, etc. When the user 104 is successfully authenticated, the mobile device 106 is configured, by the SDK 110, through the service provider 112, to retrieve the private key from the secure location in the mobile device 106 and to sign the challenge with the private key. The mobile device 106 is configured, by the SDK 110, to return the signed challenge along with the credential ID to the FIDO server 114.

The FIDO server 114, in turn, is configured to retrieve the public key corresponding to the credential ID and to verify the signature on the challenge with the public key. When the signature is successfully verified, the FIDO server 114 is configured to return an indication of authentication to the service provider 112. The service provider 112 is configured to then indicate the successful authentication, and to provide an authentication token, to the first party 102. The token is specific to the session (and also the session ID), and also the mobile device 106 (e.g., based on a device ID unique to the mobile device 106, etc.).

The first party 102 is configured to retrieve the user profile for the user 104 based on the authentication token (for the same session, based on the session ID for the current session being the same as the reference session ID when the session was initiated) from the service provider 112. Based on the authentication token, the service provider 112, in turn, is configured to locate the user profile and any accounts enrolled for the user profile (e.g., through one or more processing network, etc.) and to return the user profile for the user 104, to the first party 102.

The first party 102 is configured to display the accounts, via the website 108, to the user 104. The user 104 is permitted to then select an account. In response, the first party 102 is configured, by the SDK 110, to transmit an instruction to initiate checkout to the service provider 112 with an identifier of the selected account. In response, the first party 102, as above, is configured to perform a user lookup based on the mobile number, email address, or identifier of the account, to provide for authentication for the C2P service. In response, the service provider 112 is configured to receive the lookup request, and to perform the requested lookup based on the mobile number, email address, identifier, etc.

Rather than responding with the indication of the existing passkey for authentication of the user 104, the service provider 112 is configured to determine that the user 104 is already authenticated, during the session through the passkey, and to also determine that the authentication is within an expiration interval (e.g., thirty seconds, one minute, etc.). In turn, the service provider 112 is configured to further validate the cookie in the browser of the mobile device 106, through verification that a device ID of the mobile device 106 is consistent with one or more prior C2P service instances with the mobile device 106 (e.g., based on historical C2P service at the mobile device 106, etc.) and potentially, the session ID being the same for the authentication token.

Next, based on the authentication of the user 104 existing unexpired (based on the expiration interval) for the session and specific to the mobile device 106, the service provider 112 is configured to compile an authentication payload for the C2P service, which includes the authentication result and payment account credential for the selected account. Finally, the service provider 112 is configured to deliver, through the SDK 110, the authentication payload to the first party 102. The payload includes an indicator of the authentication being successful for the user 104. Based on the authentication payload, the first party 102, in turn, is configured to initiate a payment account transaction for the selected product(s), through an acquirer associated with the first party 102, a processing network, and an issuer of the selected account used to fund the purchase. The contents of the authorization initiated from the transaction may be included, at least in part, in the authentication payload, and/or received from the user profile, etc. In response, the first party 102 is configured to receive an authorization reply, which indicates that the transaction is approved by the issuer.

The first party 102 is configured to then indicate to the user 104, at the mobile device 106, that the transaction is successful.

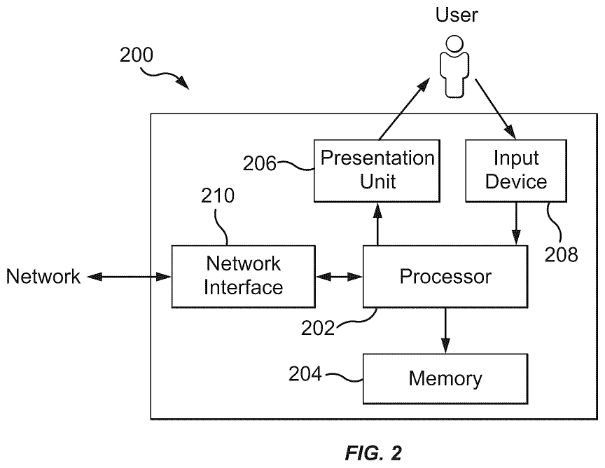

FIG. 2 illustrates an example computing device 200, which may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In at least one embodiment, the computing device 200 is accessed (for use as described herein) as a cloud, fog and/or mist type computing device. With that said, the system 100 should not be considered to be limited to the computing device 200, as described below, as different computing devices and/or arrangements of computing devices may be used. In addition, different components and/or arrangements of components may be used in other computing devices.

It should be appreciated that each of the first party 102, the mobile device 106, the service provider 112 and the FIDO server 114, etc., in the system 100 are implemented herein in one or more computing devices, such as computing device 200 illustrated in FIG. 2. In connection therewith, the one or more computing devices are each in communication with one or more other entities via at least one of the networks described herein. In general, each of the paths included in FIG. 1, along which, or via which, messages are exchanged in the above description, are representative of the network(s).

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, challenges, key pairs, user profiles, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 and/or other computer system components configured to perform one or more of the various operations herein, and may effectively transform the computing device 200 into a special purpose computing device. It should be appreciated that the memory 204 may include a variety of different memories, each implemented in one or more of the functions or processes described herein.

In the example embodiment, the computing device 200 also includes a presentation unit 206 that is coupled to the processor 202 (however, it should be appreciated that the computing device 200 could include output devices other than the presentation unit 206, etc.). The presentation unit 206 outputs information (e.g., instruction to authentication, available accounts to select, etc.), either visually or audibly to the user 104 or other information to other users associated with any of the entities illustrated in FIG. 1, at a respective computing device, etc. It should be further appreciated that various interfaces may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from users (i.e., user inputs) such as, for example, biometrics, PINs, payment account selects, etc., from the user 104 or other information from other users in the system, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks and/or one or more other computing devices herein.

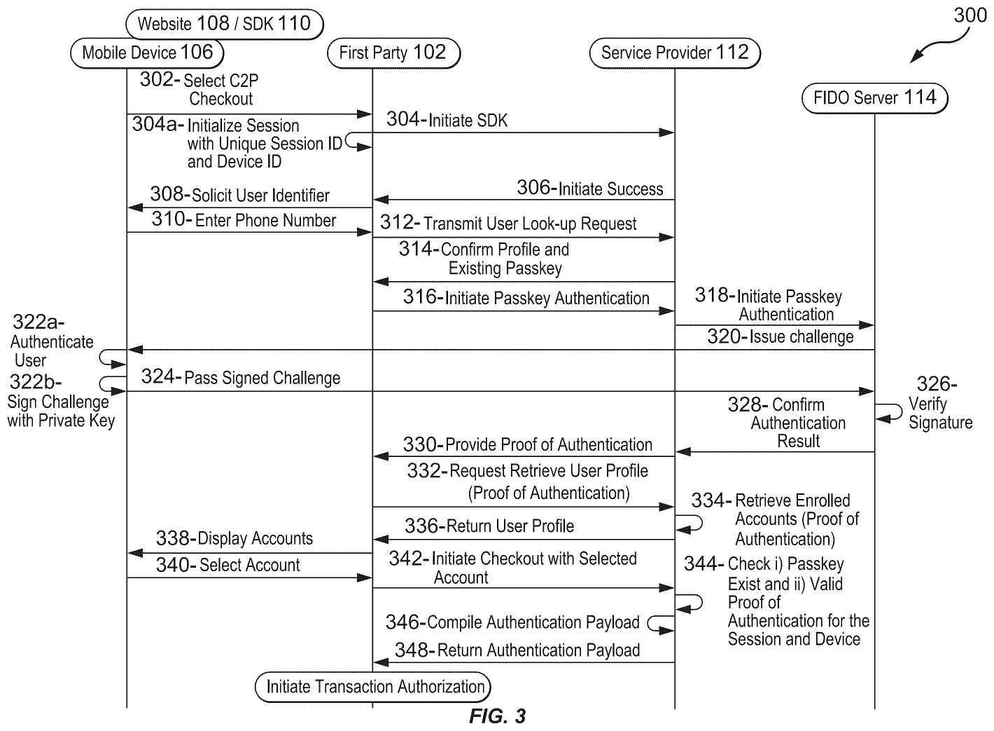

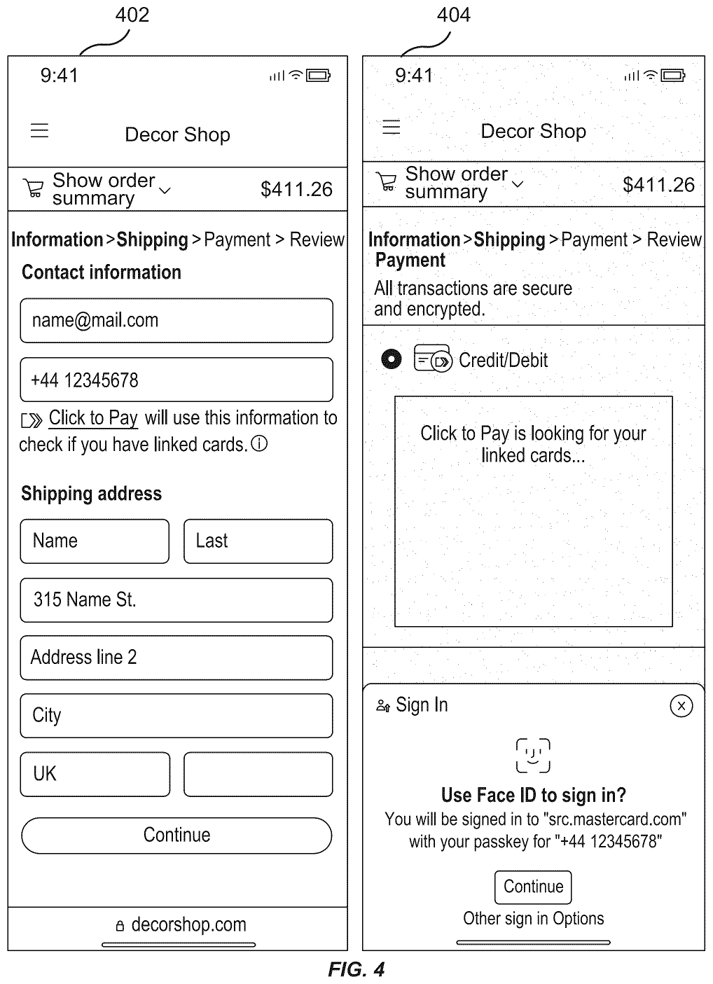

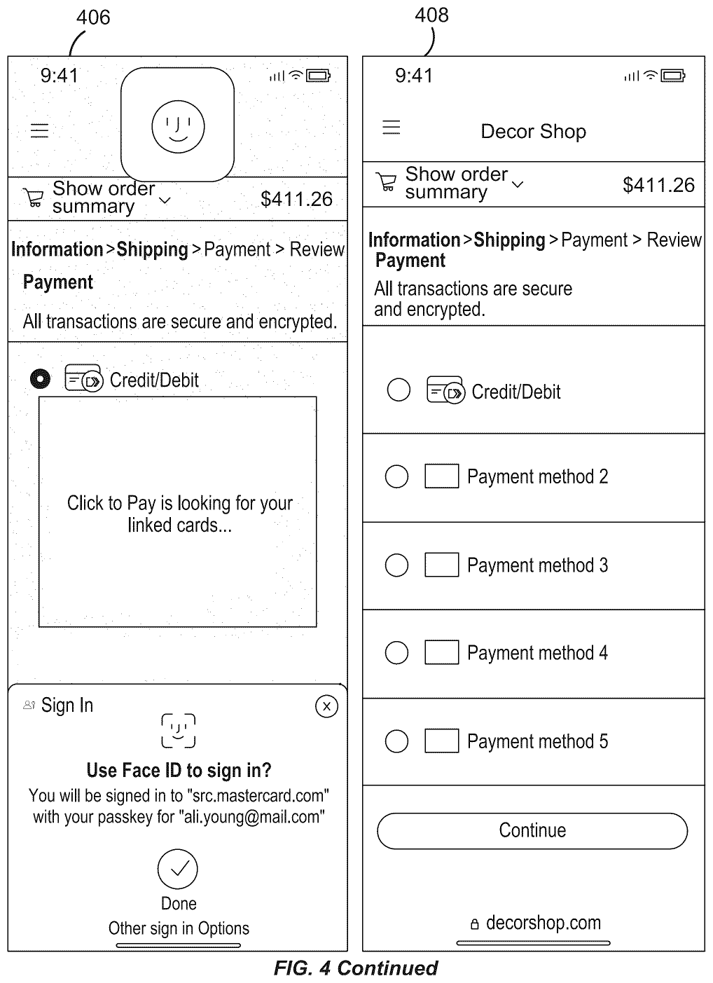

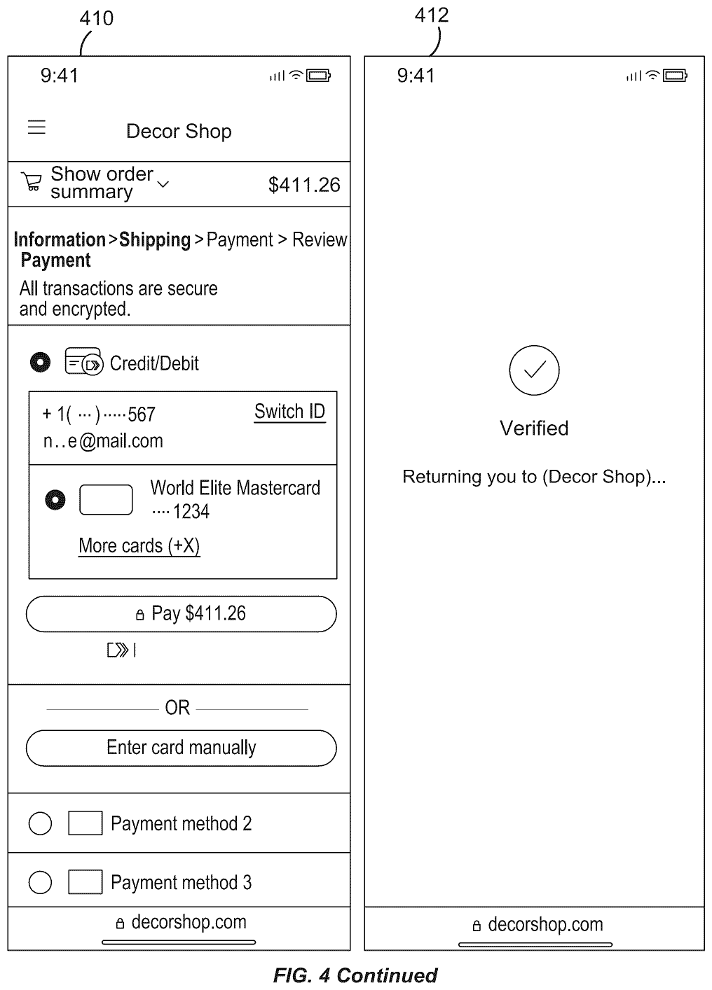

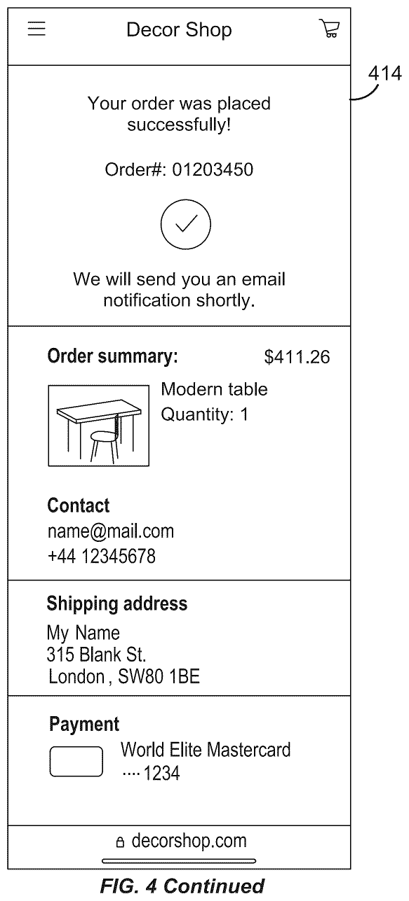

FIG. 3 illustrates an example method 300 for use in extending authentication. The example method 300 is described (with reference to FIG. 1) as generally implemented in the system 100, and with further reference to the computing device 200. As should be appreciated, however, the methods herein should not be understood to be limited to the example system 100 or the example computing device 200, and the systems and the computing devices herein should not be understood to be limited to the example method 300. The method 300 is also described with reference to interfaces 402-414 includes in FIG. 4, which, again, should not be understood to limit the methods described herein to any particular interfaces or content of interfaces, etc.

At the outset, it should be appreciated that the user 104 is enrolled with the service provider 112, whereby the user 104 and the mobile device 106 are also enrolled with the FIDO server 114 such that a key pair exists and is stored in the appropriate mobile device 106 and the FIDO server 114 as explained above.

The user 104 then access the website 108 (including the SDK 110) and adds a product to purchase from the first party 102. The user 104 then proceeds to checkout at the website 108, and selects, at 302, the C2P or click-to-pay checkout option.

In response to the selection, the first party 102 initiates the SDK 110, at 304, in this example embodiment, which establishes communication between the mobile device 106 of the user 104, the first party 102 and the service provider 112 (which offers the C2P checkout option as a service). In addition, at 304a, the first party 102 also initiates a checkout session in the website 108, which is associated with a unique session ID generated by the first party 102 (e.g., by the website 108 as a reference session ID for the entire session, etc.). The session is also associated with the unique device ID specific to the mobile device 106. The session ID is part of a session cookie stored in memory at the mobile device 106 (e.g., by the website 108, etc.). In this way, the session ID is identifiable to the specific checkout session to the exclusion of other sessions (even at the same website 108). It should be understood if the website 108 is closed at this time in method 300 (or later), the session is ended and the session ID, along with the session cookie, are deleted or otherwise inoperative/invalid, whereby different session IDs would be associated with any subsequent checkout sessions.

The service provider 112 indicates, at 306, that the SDK 110 is initiated successfully, indicating communication between the service provider 112 and the mobile device 106 and/or the first party 102.

Based on the same, the first party 102 solicits, at 308, an account identifier from the user 104. The account identifier may be any suitable proxy for the account and/or the user 104, such as, for example, an email address, mobile phone number, etc. In this example, at 310, the user 104 enters a mobile phone number specific to the mobile device 106 (e.g., a smartphone, etc.). In other examples, the user 104 may enter an email address, other phone number, or other identifier sufficient to identify the user 104 to the service provider 112. FIG. 4 illustrates an example sequence of interfaces that may be implemented in connection therewith. In particular, interface 402 of the website 108 may be displayed at the user's mobile device 106, which solicits the account identifier from the user 104, which, as shown, includes a mobile phone number (which is +44 1234578 in this example), email address (which is name@email.com in this example), etc.

The first party 102 transmits, at 312, a look-up request to the service provider 112, which includes the phone number (or other identifier as appropriate). In turn, the service provider 112 receives the look-up request and performs the requested look-up based on the mobile phone number, to identify a user profile specific to the user 104. The user profile includes, at least, the mobile phone number and an indication as to whether a passkey exists for the user profile and, by extension, for the user 104 and the mobile device 106 for the service provider 112. Here, as indicated above, the user 104 is enrolled with the FIDO server 114, whereby the user profile is included and the passkey exists (e.g., which may be specific to the first party 102 and/or the service provider 112, etc.). As such, at 314, the service provider 112 confirms the user profile has been identified and that the passkey exists in the user profile for the user 104 and/or the mobile device 106.

Based on the confirmation, the first party 102 initiates, at 316, through the service provider 112 (or directly with the FIDO server 114), a passkey authentication of the user 104. In connection therewith, the service provider 112 initiates passkey authentication with the FIDO server 114, at 318. In doing so, the service provider 112 provides the mobile phone number, or email address or other identifier (e.g., payment account number, etc.) for the user 104 or the mobile device 106, to the FIDO server 114. The FIDO server 114 then locates the credential ID for the user 104 (which identifies the public key for the user 104 and/or the mobile device 106) and further identifies the mobile device 106. Next, at 320, the FIDO server 114 generates a challenge (e.g., random number, token, etc.), stores the challenge in memory, and then issues the challenge to the mobile device 106, via the SDK 110. It should be appreciated that the challenge may be issued through the first party 102 and/or website 108 in other embodiments. Upon receipt of the challenge, the mobile device 106 authenticates, at 322a, the user 104 locally at the mobile device 106. The authentication may include, as above, biometric authentication based on a facial image, fingerprint, etc., or PIN authentication, etc., based on a locally stored biometric reference or PIN reference (e.g., consistent with the data used to access the mobile device 106, etc.). As shown in FIG. 4, the example interface 404 solicits a biometric (i.e., Face ID, etc.) from the user 104 to sign in, and the example interface 406 then indicates the successful authentication of the user 104 using the biometric authentication.

Referring again to FIG. 3, based on the authentication, the mobile device 106 retrieves the private key from the secure location therein and signs, at 322b, the challenge with the private key. The mobile device 106 then passes, at 324, the signed challenge to the FIDO server 114.

The FIDO server 114, in response, retrieves the public key for the user 104 and/or the mobile device 106 based on the credential ID (or otherwise) and then verifies, at 326, using the public key (i.e., paired with the private key used to sign the challenge at the mobile device 106) the signature on the challenge. When the signature is verified, the FIDO server 114 confirms, at 328, the successful authentication result to the service provider 112. The service provider 112 then provides a proof of authentication to the first party 102, at 330. The proof of authentication may include an authentication token (e.g., IDtoken, etc.), or other suitable data indicating the same, etc. It should be appreciated that the session ID is associated with the authentication token, for example, in one or more cookies generated by the website 108. In one or more embodiments, the authentication token is also associated with an expiration interval (which is initiated upon receipt of the authentication token), as explained below.

At 332, the first party 102 (as part of the same session) then requests to retrieve the user profile with the proof of authentication. Based on the proof of authentication and the mobile phone number, the service provider 112 retrieves, at 334, the user profile and one or more accounts enrolled for the user profile (e.g., through one or more processing networks, etc.). For example, the service provider 112 may initiate a communication with MASTERCARD processing network (not shown) to identify accounts associated with the user profile, based on the proof of authentication, and initiate the same communication to the VISA processing network (not shown), or issuers associated with accounts (not shown), etc. When the accounts are identified to the service provider 112, at 336, the service provider 112 returns the user profile, along with the identified account(s), to the first party 102.

At 338, the first party 102 displays the accounts, via the website 108, to the user 104 at the mobile device 106. The user 104 is permitted to then select an account for the identified, displayed account(s). FIG. 4 includes an example interface 408, which includes five different accounts associated with the user profile, from which the user 104 is to select one account to fund the purchase at the first party 102. The user 104 selects, at 340, one of the accounts (for example, as illustrated in interface 410 in FIG. 4). In response, the first party 102 initiates checkout with the selected account, at 342, with the service provider 112 (for example, as illustrated in interface 412 in FIG. 4).

Upon receipt of the initiated checkout, the service provider 112 is configured to lookup the profile associated with the user 104, based on the mobile phone number, email address, or other identifier, etc. In doing so, the service provider 112 confirms that the passkey exists for the user profile, at 344. As part of 344, rather than initiating a passkey authentication with the existing passkey, the service provider 112 confirms that the valid proof of authentication exists for the session based on the session ID and the mobile device 106. That is, the service provider 112 compares the session ID for the proof of authentication, as stored, for example, in the cookie (i.e., reference session ID), at the website 108, etc., and the session ID of the current checkout session at the mobile device 106. When there is a match, the proof of authentication is validated and confirmed. What's more, the service provider 112 may further validate the device ID of the mobile device 106 (e.g., ESN, MAC address, etc.) against one or more historical transactions including the same user profile, as an indication of historical link between the mobile device 106 and usage of the C2P service from the service provider 112. It should be appreciated that the device ID is stored, for use as described, as part of the cookie included at the website 108 (e.g., under the service provider domain and/or the first party context, etc.).

In addition, the proof of authentication may be associated with an expiration interval (e.g., ten second, thirty second, one minute, or more or less, etc.), and the proof of authentication is confirmed to be validated based on the expiration interval still being unexpired at the time that the checkout is initiated with the service provider 112. Conversely, when the expiration interval is expired (or the other validations above fail), the proof of authentication is not valid, and the service provider 112 is required to repeat the passkey authentication with the user 104 at the mobile device 106.

In this way, the service provider 112 gains assurance that the mobile device 106 and the user 104 are properly authenticated and are involved in the transaction, yet without the duplicative passkey authentications of the user 104 during the same pending checkout session.

Next, at 346, the service provider 112 compiles an authentication payload for the C2P service, which includes the authentication result and payment account credential for the selected account. Finally, the service provider 112 returns, at 348, the authentication payload to the first party 102. The first party 102, in turn, initiates a transaction authorization for the transaction, as is conventional, through an acquirer associated with the first party 102, a processing network, and the issuer of the selected account. In response, the first party 102 is configured to receive an authorization reply, which indicates that the transaction is approved by the issuer.

The first party 102 is configured to then indicate to the user 104, at the mobile device 106, that the transaction is successful (for example, as illustrated in interface 414 of FIG. 4).

In view of the above, the systems and methods and computer-readable storage media herein uniquely provide for extending authentication through a session, based on an initial passkey authentication, whereby a subsequent passkey authentication specific to checkout (rather than user lookup) is omitted. In this way, repeated authentication of users may be avoided during singular sessions. As a result, network traffic between the first party, the mobile device, the service provider and also the FIDO server is reduced. For example, where a second passkey authentication is avoided, the four transmissions for each passkey authentication, as shown in FIG. 3, are omitted. The number of omitted messages, while generally preserving security, increases substantially as more repeated passkey authentications are omitted over millions of interactions, etc. In this manner, the systems and methods herein provide a technical solution of tying passkey authentication results to session IDs to extend the authentication result commensurate with a browser session to limit excessive network traffic, thereby solving a technical problem.

Again, and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations as recited herein and/or in the following claims, including, for example (and without limitation): during a checkout session for a website of a first party at a mobile device specific to a user, where the session is associated with a session ID: (a) in response to a lookup request from a first party, confirming a user profile for a user and an existing passkey for the user profile and a mobile device associated with the user; (b) initiating a passkey authentication of the user, through a fast identity online (FIDO) server at the mobile device; (c) receiving a proof of authentication for the user from the FIDO server, whereby the proof of authentication is associated with the session ID; (d) providing the proof of authentication to the first party; (e) receiving an instruction to initiate checkout from the first party; (f) validating the proof of authentication based on the session ID, without a further passkey authentication of the user; (g) compiling an authentication payload based on the validated proof of authentication; and/or (h) returning the authentication payload to the first party, in response to the instruction to initiate checkout.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9, and so forth.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for extending authentication during a browser session, the method comprising:
during a checkout session for a website of a first party at a mobile device specific to a user, where the checkout session is associated with a session ID:
in response to a look-up request from the first party, confirming a user profile for the user and an existing passkey for the user profile and a mobile device associated with the user;
initiating, by a service provider computing device, a passkey authentication of the user, through a fast identity online (FIDO) server at the mobile device;
receiving, by the service provider computing device, a proof of authentication for the user from the FIDO server, whereby the proof of authentication is associated with the session ID;
providing, by the service provider computing device, the proof of authentication to the first party;
receiving, by the service provider computing device, an instruction to initiate checkout from the first party;
validating, by the service provider computing device, the proof of authentication based on the session ID, without a further passkey authentication of the user;
compiling, by the service provider computing device, an authentication payload based on the validated proof of authentication; and
returning the authentication payload to the first party, in response to the instruction to initiate checkout.

2. The computer-implemented method of claim 1, wherein the service provider computing device is configured to communicate with the first party through one of a software-development kit (SDK) integrated with the website of the first party or an application programming interface (API) accessed by the first party.

3. The computer-implemented method of claim 1, wherein the look-up request includes a phone number of the mobile device.

4. The computer-implemented method of claim 1, further comprising:
receiving, by the service provider computing device, a request to retrieve the user prolife;
retrieving one or more enrolled accounts for the user profile; and
returning, by the service provider computing device, the user profile and the retrieved enrolled accounts to the first party, prior to receiving the instruction to initiate checkout; and
wherein the instruction to initiate checkout includes a selection of one of the one or more enrolled accounts.

5. The computer-implemented method of claim 1, wherein validating the proof of authentication includes:
validating a session ID linked to the proof of authentication matches said session ID of the session;
validating a device ID of the mobile device to the user profile based on historical transaction, through the service provider computing device; and
validating an expiration interval for the proof of authentication is not expired.

6. The computer-implemented method of claim 1, wherein validating the proof of authentication includes:
validating a session ID linked to the proof of authentication matching said session ID of the session; and
validating an expiration interval for the proof of authentication is not expired.

7. The computer-implemented method of claim 1, wherein the service provider computing device and the FIDO server are included in a processing network.

8. A non-transitory computer-readable storage medium comprising executable instructions for extending authentication, which when executed by at least one processor, cause the at least one processor to:
as part of a checkout session for a website of a first party at a mobile device specific to a user, where the checkout session is associated with a reference session ID:
in response to a lookup request from the first party, confirm a user profile for the user and an existing passkey for a mobile device associated with the user;
initiate a passkey authentication of the user, through a fast identity online (FIDO) server and the mobile device;
receive a proof of authentication for the user from the FIDO server, whereby the proof of authentication is associated with the session ID, and based on a FIDO challenge to the user at the mobile device;
provide the proof of authentication to the first party;
receive an instruction to initiate checkout from the first party;
validate the proof of authentication based on a session ID of the current session at the website being consistent with the reference session ID, without a further passkey authentication of the user between the FIDO server and the mobile device during said session;
compile an authentication payload based on the validated proof of authentication; and
return the authentication payload to the first party, in response to the instruction to initiate checkout.

9. The non-transitory computer-readable storage medium of claim 8, wherein the executable instructions, when executed by the at least one processor, cause the at least one processor to:
communicate with the first party through a software-development kit (SDK) integrated with the website of the first party.

10. The non-transitory computer-readable storage medium of claim 8, wherein the executable instructions, when executed by the at least one processor, cause the at least one processor to:
receive a request to retrieve the user prolife;
retrieve one or more enrolled accounts for the user profile; and
return the user profile and the retrieved enrolled accounts to the first party, prior to receiving the instruction to initiate checkout;
wherein the instruction to initiate checkout includes a selection of one of the one or more enrolled accounts.

11. The non-transitory computer-readable storage medium of claim 8, wherein the executable instructions, when executed by the at least one processor, cause the at least one processor, in validating the proof of authentication, to:
validate a device ID of the mobile device to the user profile based on historical transaction, through the service provider computing device.

12. The non-transitory computer-readable storage medium of claim 11, wherein the executable instructions, when executed by at least one processor, cause the at least one processor, in validating the proof of authentication, to:
validating an expiration interval for the proof of authentication is not expired.

13. A system for extending authentication during a browser session, the system comprising:
a fast identity online (FIDO) server; and
a service provider computing device coupled in communication with the FIDO server;
wherein the service provider computing device is configured, by first executable instructions, as part of a checkout session for a website of a first party at a mobile device specific to a user, where the checkout session is associated with a session ID, to:
in response to a look-up request from the first party, confirm a user profile for the user and an existing passkey for the user profile and a mobile device associated with the user;
initiate a passkey authentication of the user, through the FIDO server at the mobile device;
wherein the FIDO server is configured, by second executable instructions, to:
issue a challenge to the mobile device;
verify a signed challenge from the mobile device, based on a public key specific to the mobile device; and
in response to the signed challenge being successfully verified, provide a proof of authentication for the user to the service provider computing device; and then
wherein the service provider computing device is configured, by the first executable instructions, to:
associate the proof of authentication to the session ID for the session;
provide the proof of authentication to the first party;
receive an instruction to initiate checkout from the first party;
validate the proof of authentication based on the session ID, without a further passkey authentication of the user;
compile an authentication payload based on the validated proof of authentication; and
return the authentication payload to the first party, in response to the instruction to initiate checkout.

14. The system of claim 13, wherein the service provider computing device is configured, by the first executable instructions, in validating the proof of authentication, to:
validate a device ID of the mobile device to the user profile based on historical transactions, through the service provider computing device.

15. The system of claim 13, wherein the service provider computing device is configured, by the first executable instructions, in validating the proof of authentication, to:
validate an expiration interval for the proof of authentication is not expired.

16. The system of claim 13, wherein the proof of authentication is an authentication token.

17. The system of claim 16, wherein the service provider computing device and the FIDO server are included in a processing network.
